(19) United States
(12) Patent Application Publication
(10) Pub. No.: US 2024/0034158 A1
(43) Pub. Date: Feb. 1, 2024

(54) APPARATUS AND METHOD OF CONTROLLING ELECTRIC VEHICLE

(71) Applicants: Hyundai Motor Company, Seoul (KR); Kia Corporation, Seoul (KR); HYUNDAI WIA CORPORATION, Changwon-si (KR)

(72) Inventors: Taewoo Lee, Suwon-Si (KR); Jeong Won Song, Hwaseong-Si (KR); Woocheol Cho, Hwaseong-Si (KR); Joonhee Lee, Yongin-Si (KR); Kyunghan Min, Incheon (KR); Sung Keun Lim, Hwaseong-Si (KR); Junseok Park, Seoul (KR); Jong Chan Lee, Hanam-Si (KR); Heon Kang, Hwaseong-Si (KR)

(73) Assignees: Hyundai Motor Company, Seoul (KR); Kia Corporation, Seoul (KR); HYUNDAI WIA CORPORATION, Changwon-si (KR)

(21) Appl. No.: 17/979,595

(22) Filed: Nov. 2, 2022

(30) Foreign Application Priority Data
Jul. 27, 2022 (KR) 10-2022-0092988

(51) Int. Cl. B60L 15/20; B60L 3/10; B60L 7/18

(52) U.S. Cl. CPC B60L 15/2054; B60L 3/10; B60L 7/18; B60L 2240/507; B60L 2240/465; B60L 2240/423; B60L 2250/26

(57) ABSTRACT

An apparatus for controlling an electric vehicle includes: a twin clutch including first and second clutches and for controlling power supplied from a driving motor to first and second rear wheels through the first clutch and the second clutch; a vehicle controller for calculating a target slip rate of the rear wheels and controlling a regenerative braking torque by the driving motor to follow the target slip rate when an entry condition for entering a drifted driving mode of the vehicle is satisfied; and a clutch controller for controlling the slip rates of the left and right rear wheels to be synchronized by adjusting clutch torques of the first and second clutches of the twin clutch.

### CROSS-REFERENCE TO RELATED APPLICATION

The present application claims priority to Korean Patent Application No. 10-2022-0092988 filed on Jul. 27, 2022, the entire contents of which is incorporated herein for all purposes by this reference.

### BACKGROUND OF THE PRESENT DISCLOSURE

### Field of the Present Disclosure

The present disclosure relates to an apparatus and a method of controlling an electric vehicle, and more particularly, to an apparatus and a method of controlling an electric vehicle, which are capable of implementing a stable drift driving mode by use of a twin clutch.

### Description of Related Art

A drift driving mode means a driving state in which slip occurs on the driving wheel by use of the driving force of a vehicle to induce the vehicle in the oversteer direction, and a steering angle of a front wheel is operated in the opposite direction of the vehicle's turning to continuously travel.

To increase a driver's driving desire in a high-performance vehicle, such as a sedan, a coupe, and a sports vehicle, and a vehicle having a sports mode in a rear-wheel drive vehicle, the drift driving mode becomes a very important marketing factor.

A differential provided in the vehicle allows the left and right driving wheels to rotate at different speeds when the vehicle is turning, but
the differential in the related art has a problem in that more power is distributed to the driving wheels having weak grip force when the grip force of the left and right driving wheels are different from each other, and sufficient power cannot be transmitted to the driving wheels having relatively large grip force. That is, in a situation in which the grip force of the left and right driving wheels is different, it is impossible to smoothly control the left and right driving wheels.

Due to the present problem, there is a problem that the drift driving mode required by the driver cannot be smoothly implemented through the differential in the related art.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and a method of controlling an electric vehicle, which are configured for smoothly implementing a drift driving mode according to a demand of a driver.

Various aspects of the present disclosure are directed to providing an apparatus of controlling an electric vehicle, the apparatus including: a twin clutch including a first clutch and a second clutch and for controlling power supplied from a driving motor to first and second rear wheels through the first clutch and the second clutch; a vehicle controller configured for determining a target slip rate of the first and second rear wheels and controlling a regenerative braking torque by the driving motor to follow the target slip rate when an entry condition for entering a drifted driving mode of the vehicle is satisfied; and a clutch controller configured for controlling slip rates of the first and second rear wheels to be synchronized by adjusting clutch torques of the first clutch and the second clutch of the twin clutch.

The entry condition may be satisfied when an accelerator pedal signal is off, a brake pedal signal is off, and a paddle shift is on for a predetermined time period.

The target slip rate may be determined based on a vehicle speed.

The target slip rate may be determined in inverse proportion to the vehicle speed.

The clutch controller may set a clutch torque corresponding to a turning internal rear wheel to be greater than a clutch torque corresponding to a turning external rear wheel among the first and second rear wheels.

When the release condition is satisfied, the vehicle controller may be configured to control the driving motor to drive the vehicle in a normal driving mode.

The release condition is satisfied when the vehicle controller receives a manipulation signal of an accelerator pedal.

Various aspects of the present disclosure are directed to providing a method of controlling an electric vehicle, the method including: determining whether an entry condition for entering a drift driving mode of the vehicle is satisfied; determining a target slip rate of first and second rear wheels of the vehicle when the entry condition is satisfied; controlling a regenerative braking torque of a driving motor of the vehicle to follow the target slip rate; and controlling slip rates of the first and second rear wheels to be synchronized by adjusting the clutch torques of the first clutch and the second clutch of a twin clutch.

The entry condition may be satisfied when an accelerator pedal signal is off, a brake pedal signal is off, and a paddle shift is on for a predetermined time period.

The target slip rate may be determined based on a vehicle speed.

The target slip rate may be determined in inverse proportion to the vehicle speed.

A clutch torque corresponding to a turning internal rear wheel may be set to be greater than a clutch torque corresponding to a turning external rear wheel.

The method may further include: determining whether a release condition is satisfied; and when the release condition is satisfied, controlling the driving motor to drive the vehicle in a normal driving mode.

The release condition may be satisfied when a manipulation signal of an accelerator pedal is detected.

According to the apparatus and the method of controlling the electric vehicle according to the exemplary embodiment of the present disclosure as described above, it is possible to stably implement a drift driving mode according to a driver's request by use of the twin clutch.

Furthermore, it is possible to improve the marketability of the vehicle by implementing the drift driving mode according to the driver's request.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

These drawings are fore reference in describing various exemplary embodiments of the present disclosure, and the technical spirit of the present disclosure should not be construed as being limited to the accompanying drawings.

FIG. 1 is a schematic diagram illustrating a configuration of an apparatus of controlling an electric vehicle according to various exemplary embodiments of the present disclosure.

FIG. 2 is a block diagram illustrating a configuration of the apparatus of controlling the electric vehicle according to the exemplary embodiment of the present disclosure.

FIG. 3 is a flowchart illustrating a method for controlling an electric vehicle according to various exemplary embodiments of the present disclosure.

FIG. 4 is a graph for explaining the method for controlling the electric vehicle according to the exemplary embodiment of the present disclosure.

FIG. 5 is a diagram illustrating a drift driving state of an electric vehicle according to various exemplary embodiments of the present disclosure.

FIG. 6 is a chart illustrating a target slip rate according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Exemplary embodiments of the present disclosure will be described more fully hereinafter with reference to the accompanying drawings, in which exemplary embodiments of the present disclosure are shown. As those skilled in the art would realize, the described exemplary embodiments of the present disclosure may be modified in various different ways, all without departing from the spirit or scope of the present disclosure.

The drawings and description are to be regarded as illustrative in nature and not restrictive, and like reference numerals designate like elements throughout the specification.

Furthermore, the size and thickness of each configuration shown in the drawings are arbitrarily illustrated for understanding and ease of description, but the present disclosure is not limited thereto, and the thickness of layers, films, panels, regions, etc., are exaggerated for clarity.

Hereinafter, an apparatus of controlling an electric vehicle according to various exemplary embodiments of the present disclosure will be described in detail with reference to the accompanying drawings.

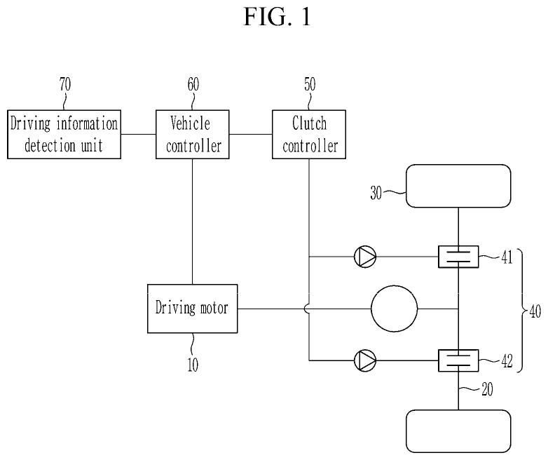

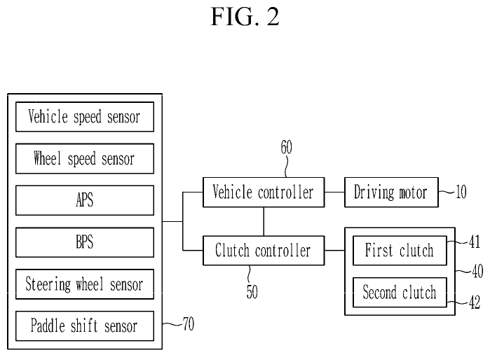

FIG. 1 is a schematic diagram illustrating a configuration of an apparatus of controlling an electric vehicle according to various exemplary embodiments of the present disclosure. Furthermore, FIG. 2 is a block diagram illustrating a configuration of the apparatus of controlling the electric vehicle according to the exemplary embodiment of the present disclosure.

As illustrated in FIG. 1 and FIG. 2, an apparatus of controlling an electric vehicle according to various exemplary embodiments of the present disclosure may include a driving motor 10, a vehicle controller 60, a twin clutch 40, and a clutch controller 50.

The driving motor 10 generates driving force necessary for driving the vehicle by electrical energy, and the driving force generated by the driving motor 10 is supplied to the driving wheels (for example, rear wheels 30) or all wheels of the vehicle, so that the vehicle travels. The driving motor 10 may generate electrical energy by operating as a generator as needed (for example, in a regenerative braking mode).

In the specification of the present disclosure, the torque generated by the driving motor 10 to drive the vehicle is referred to as the drive torque, and the reverse torque generated by the driving motor 10 operating as a generator when the vehicle is coasting or braking is referred to as a regenerative braking torque.

The twin clutch 40 is provided on an axle 20 mounted on the driving wheel 30 and includes a first clutch 41 and a second clutch 42 provided on both sides of the axle 20 behind a reducer output shaft. According to the engagement and disengagement of the twin clutch 40, the driving force supplied from the driving motor 10 to the driving wheel 30 is supplied or blocked to the driving wheel 30 (for example, the rear wheel), and when necessary, the driving force supplied to the driving wheel is adjusted.

Each of the first clutch 41 and the second clutch 42 of the twin clutch 40 includes a clutch plate and a clutch disc, and the clutch plate and the clutch disc are coupled by hydraulic pressure generated by the hydraulic pump. That is, the clutch is coupled by coupling the clutch plate and the clutch disc through the hydraulic pressure generated by the hydraulic pump. Conversely, when hydraulic pressure is not generated in the hydraulic pump, the coupling between the clutch plate and the clutch disc is released, so that the engagement of the clutch is released.

In the exemplary embodiment of the present disclosure, by independently adjusting the amount of the hydraulic pressure applied to each of the first clutch 41 and the second clutch 42 forming the twin clutch 40, the torque applied to each clutch (hereinafter, referred to as ‘clutch torque’ as necessary) may be controlled. By independently controlling the torque applied to each clutch, the size of the driving force distributed to the driving wheel 30 through the clutches 41 and 42 is adjusted. The amount of hydraulic pressure generated by the hydraulic pump and applied to each clutch may be mapped to a torque applied to each clutch. The torque applied to the clutch according to the amount of the hydraulic pressure may be determined by an experiment and stored in the clutch controller 50 in advance.

The vehicle controller 60 may control various components necessary for driving of the vehicle including the driving motor 10, and may perform cooperative control with the clutch controller 50 as necessary.

The clutch controller 50 and the vehicle controller 60 may be implemented integrally or may be implemented distributed (or separately). In the specification of the present disclosure, a case in which the clutch controller 50 and the vehicle controller 60 are distributed and implemented will be referred to as an example.

The clutch controller 50 and the vehicle controller 60 may be provided with one or more processors operating according to a set program, and the set program is configured to perform each step of the method of controlling the electric vehicle including the twin clutch 40 according to the exemplary embodiment of the present disclosure.

On the other hand, the apparatus of controlling the electric vehicle according to the exemplary embodiment of the present disclosure includes a driving information detection unit 70 for detecting driving information required for driving of the vehicle, and the driving information detected by the driving information detection unit 70 is transmitted to the clutch controller 50 and the vehicle controller 60.

The driving information may include a vehicle speed, a wheel speed, the amount of opening of an accelerator pedal, the amount of opening of a brake pedal, a turning state of the vehicle, and an operation signal of a paddle shift (for example, an on and/or off signal of a paddle shift).

To the present end, the driving information detection unit 70 may include a vehicle speed sensor which is configured to detect the vehicle speed; a wheel speed sensor which is configured to detect the speed of the wheel; an accelerator pedal sensor (APS) that detects the amount of opening of the accelerator pedal; a brake pedal sensor (BPS) that detects the amount of opening of the brake pedal, a steering angle sensor of the steering wheel that detects the turning state of the vehicle (or a lateral acceleration sensor configured for measuring which is configured to measure the lateral acceleration of the vehicle, or, a yaw rate sensor which is configured to detect a yaw rate of the vehicle), and a paddle shift sensor

The amount of opening of the accelerator pedal detected by the accelerator pedal sensor may be between 0% (in a state in which the driver does not depress the accelerator pedal) and 100% (in a state in which the driver fully depresses the accelerator pedal), and the amount of opening of the brake pedal detected by the brake pedal sensor may be between 0% (in a state in which the driver does not depress the brake pedal) and 100% (in a state in which the driver fully depresses the brake pedal).

In the paddle shift, a first paddle shift for downshift and a second paddle shift for upshift are respectively mounted on both sides of the steering wheel, and the driver operates the paddle shift while holding the steering wheel with the hand to rapidly performing shifting.

Hereinafter, the operation of the electric vehicle including the twin clutch according to the exemplary embodiment of the present disclosure as described above will be described in detail with reference to the accompanying drawings.

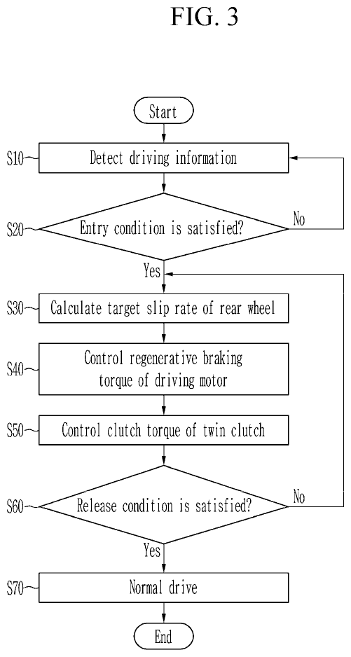

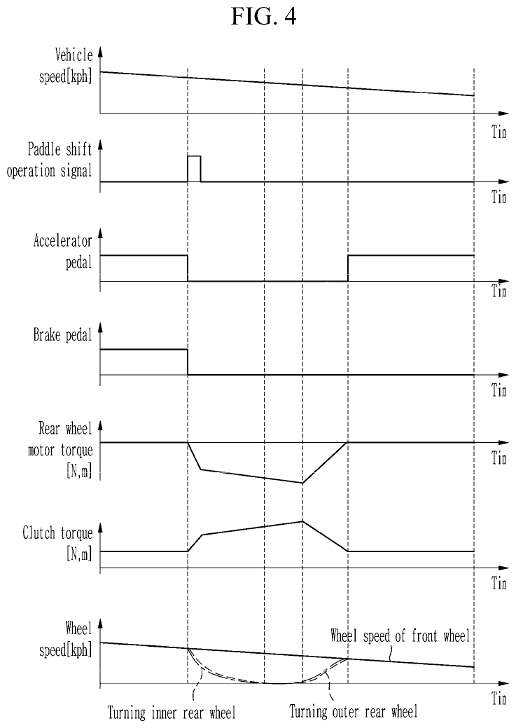

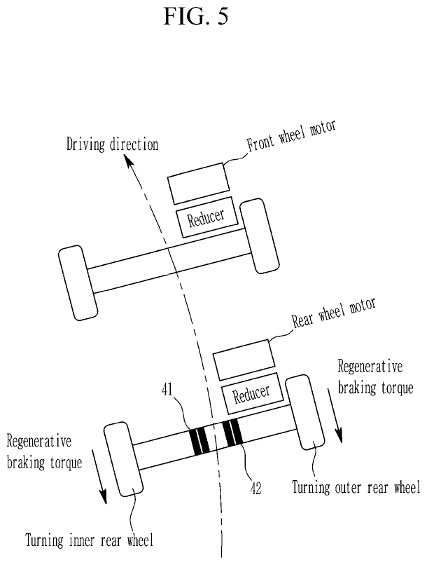

FIG. 3 is a flowchart illustrating a method for controlling an electric vehicle according to various exemplary embodiments of the present disclosure. FIG. 4 is a graph for explaining the method for controlling the electric vehicle according to the exemplary embodiment of the present disclosure. FIG. 5 is a diagram illustrating a drift driving state of an electric vehicle according to various exemplary embodiments of the present disclosure.

Referring to FIG. 3, FIG. 4, and FIG. 5, the driving information detection unit 70 detects driving information required for driving of the vehicle, and the detected driving information is transmitted to the vehicle controller 60 and the clutch controller 50 (S10). Here, because the driving information detected by the driving information detection unit 70 is the same as described above, a detailed description thereof will be omitted.

The vehicle controller 60 determines whether an entry condition for entering a drifted driving mode is satisfied in a turning driving state (S20).

Here, the entry condition for entering the drift driving mode may be satisfied when an accelerator pedal signal is off (or the amount of opening of the accelerator pedal is 0%), and when the brake pedal signal is off (or the amount of opening of the brake pedal is 0%), and when the paddle shift is on for a predetermined time period (for example, 2 seconds) or longer.

When the entry condition is satisfied, the vehicle controller 60 determines a target slip rate (or the amount of slip) of the rear wheels (S30).

A target slip rate of the rear wheels is determined based on the current vehicle speed, stored in advance in the vehicle controller 60 in the form of map data, and may be determined through Equation 1 below.

Target slip rate=(vehicle speed-wheel speed)/vehicle speed*100% [Equation 1]

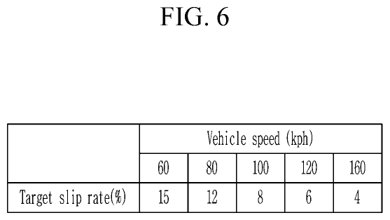

In the exemplary embodiment of the present disclosure, the target slip rate may be determined to be inversely proportional to the vehicle speed (refer to FIG. 6). That is, when the vehicle travels at a relatively high speed, the target slip rate is set low, and when the vehicle travels at a relatively low speed, the target slip rate is set low, so that the vehicle may smoothly enter the drift driving mode.

The vehicle controller 60 is configured to control the regenerative braking torque of the driving motor 10 to follow the target slip rate (S40). In the instant case, the vehicle controller 60 operates the driving motor 10 as a generator to generate a regenerative braking torque for follow the target slip rate. That is, the vehicle controller 60 generates the regenerative braking torque by the driving motor 10 to generate slip in the rear wheels, and is configured to control the regenerative braking torque of the driving motor 10 so that the slip generated in the rear wheels follows the target slip rate.

When the vehicle turns and travels, a difference occurs in the amount of slip (or slip rate) generated in the left and right rear wheels. For example, when the vehicle is turning in the left direction, since the vehicle's load is more applied to the left wheel, the amount of slip generated by the left rear wheel (or the turning internal rear wheel) becomes greater than the amount of slip generated by the right rear wheel (or the turning external rear wheel).

In the instant case, since a difference occurs in the slip amount of the left and right rear wheels, the vehicle behaves unless the driver wants it to.

To solve the present problem, the clutch controller 50 adjusts the clutch torques of the first clutch 41 and the second clutch 42 of the twin clutch 40 to control the slip rates of the left and right rear wheels to be synchronized (S50).

In the instant case, the clutch controller 50 adjusts the clutch torques of the first clutch 41 and the second clutch 42 so that the clutch torque corresponding to the turning internal rear wheel is greater than the clutch torque corresponding to the turning external rear wheel. Furthermore, the clutch controller 50 is configured to control the smaller value between the clutch torques of the first clutch 41 and the second clutch 42 to be greater than the regenerative braking torque by the driving motor 10.

The vehicle controller 60 determines whether a release condition for escaping from the drift driving mode is satisfied (S60). Here, the release condition may be satisfied when a manipulation signal of the accelerator pedal is detected by the driving information detection unit 70 (or when the amount of opening of the accelerator pedal is equal to or greater than a set value).

When the release condition is satisfied, the vehicle controller 60 releases the drift driving mode and is configured to control the driving motor 10 so that the vehicle travels in the normal driving mode (S70).

According to the apparatus and the method of controlling an electric vehicle according to the exemplary embodiment of the present disclosure as described above, when the driver wants to enter the drift driving mode, the driving mode may enter the drift driving mode through paddle shift, and the drift driving mode may be implemented by generating the slip in the rear wheels through the regenerative braking torque of the driving motor 10.

As described above, because the vehicle may enter the drift driving mode through various factors, such as entering the drift driving mode through the paddle shift, it is possible to secure the marketability of a high-performance vehicle and provide the driver with fun-to-drive.

Furthermore, when the vehicle enters the drift driving mode, the amount of slip of the turning internal rear wheel is synchronized to the amount of slip of the turning external rear wheel through the twin clutch 40, preventing abnormal behavior of the vehicle during drift driving.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus of controlling a vehicle, the apparatus comprising:
a twin clutch including a first clutch and a second clutch and for controlling power supplied from a driving motor to first and second rear wheels through the first clutch and the second clutch;
a vehicle controller configured for determining a target slip rate of the first and second rear wheels and controlling a regenerative braking torque by the driving motor to follow the target slip rate when an entry condition for entering a drifted driving mode of the vehicle is satisfied; and
a clutch controller configured for controlling slip rates of the first and second rear wheels to be synchronized by adjusting clutch torques of the first clutch and the second clutch of the twin clutch.

2. The apparatus of claim 1, wherein the entry condition is satisfied when an accelerator pedal signal is off, a brake pedal signal is off, and a paddle shift is on for a predetermined time period.

3. The apparatus of claim 1, wherein the target slip rate is determined based on a vehicle speed.

4. The apparatus of claim 3, wherein the target slip rate is determined in inverse proportion to the vehicle speed.

5. The apparatus of claim 1,
wherein the clutch controller is configured to set a clutch torque corresponding to a turning internal rear wheel to be greater than a clutch torque corresponding to a turning external rear wheel among the first and second rear wheels.

6. The apparatus of claim 1,
wherein the clutch controller is configured to control a smaller value between the clutch torques of the first clutch and the second clutch to be greater than the regenerative braking torque by the driving motor.

7. The apparatus of claim 1, wherein when the release condition is satisfied, the vehicle controller is configured to control the driving motor to drive the vehicle in a normal driving mode.

8. The apparatus of claim 7, wherein the release condition is satisfied when the vehicle controller receives a manipulation signal of an accelerator pedal.

9. A method of controlling a vehicle, the method comprising:
determining whether an entry condition for entering a drift driving mode of the vehicle is satisfied;
determining a target slip rate of first and second rear wheels of the vehicle when the entry condition is satisfied;
controlling a regenerative braking torque of a driving motor of the vehicle to follow the target slip rate; and
controlling slip rates of the first and second rear wheels to be synchronized by adjusting clutch torques of a first clutch and a second clutch of a twin clutch.

10. The method of claim 9, wherein the entry condition is satisfied when an accelerator pedal signal is off, a brake pedal signal is off, and a paddle shift is on for a predetermined time period.

11. The method of claim 9, wherein the target slip rate is determined based on a vehicle speed.

12. The method of claim 11, wherein the target slip rate is determined in inverse proportion to the vehicle speed.

13. The method of claim 9, wherein a clutch torque corresponding to a turning internal rear wheel among the first and second rear wheels is set to be greater than a clutch torque corresponding to a turning external rear wheel among the first and second rear wheels.

14. The method of claim 9,
wherein a clutch controller of the vehicle is configured to control a smaller value between the clutch torques of the first clutch and the second clutch to be greater than the regenerative braking torque by the driving motor.

15. The method of claim 9, further including:
determining whether a release condition is satisfied; and
when the release condition is satisfied, controlling the driving motor to drive the vehicle in a normal driving mode.

16. The method of claim 15, wherein the release condition is satisfied when a manipulation signal of an accelerator pedal is detected.
